(19) United States
(12) Patent Application Publication
(10) Pub. No.: US 2021/0326086 A1
(43) Pub. Date: Oct. 21, 2021

(54) INFORMATION PROCESSING APPARATUS, COMPUTER-READABLE RECORDING MEDIUM STORING CONTROL PROGRAM, AND CONTROL METHOD

(71) Applicant: KONICA MINOLTA, INC., Tokyo (JP)

(72) Inventor: Yasuaki SUGIMOTO, Tokyo (JP)

(73) Assignee: KONICA MINOLTA, INC., Tokyo (JP)

(21) Appl. No.: 17/191,803

(22) Filed: Mar. 4, 2021

(30) Foreign Application Priority Data
Apr. 20, 2020 (JP) 2020-074771

(51) Int. Cl. G06F 3/12; G06F 9/451

(52) U.S. Cl. CPC G06F 3/1256; G06F 3/1274; G06F 9/453; G06F 3/1222; G06F 3/1238

(57) ABSTRACT

An information processing apparatus includes a determiner and a provider. The determiner executes, as determination of usefulness, a first determination that determines whether or not a setting content of a job and a content of a help screen coincide, in a case where an operation display has displayed a help screen and thereafter has received execution start of a job corresponding to an operation screen associated with the help screen, and the provider provides a useful tag as an identifier to a help scree determined by the determiner such that a determination result of a first determination is “Yes” and makes a memory unit memorize this matter.

### CROSS-REFERENCE TO RELATED APPLICATION

The entire disclosure of Japanese patent application No. 2020-074771, filed on Apr. 20, 2020, is incorporated herein by reference in its entirety.

### BACKGROUND

### 1. Technical Field

The present invention relates to an information processing apparatus, a computer-readable recording medium storing a control program, and a control method.

### 2. Description of Related Arts

In an information processing apparatus, such as an image processing apparatus, on an operation screen, it becomes possible to execute a setting operation in a plurality of functions and each function, to register as a job, and to execute the job.

On the other hand, in the case where a user performs various kinds of settings with regard to an operation in an information processing apparatus, it has been known that, by pressing a help key in a state of displaying a setting screen, a help screen or help information is displayed and a commentary with regard to setting is indicated. (for example, Patent Literature 1 (JP 2001-147797A), Patent Literature 2 (JP 2011-066840A)).

### SUMMARY

However, like Patent Literature 1, in the case where only a simple commentary for a setting item is provided, it may be permissible to display the same help all the time. However, for example, in the setting of a job of MFP, since there are many functions and setting items, the contents of the setting are complicated. Moreover, there may be a case where the setting is changed depending on the usage. Accordingly, a more detailed help, such as a specific using method and setting method, is made necessary. Moreover, actually, depending on job setting, it is not uncommon also a case where a plurality of pages is allocated in a manual book.

Among such help information across a plurality of pages and multiple pieces of help information, information really necessary for use environment and usage of a user varies depending on the use environment and usage. Even for help against the same setting item, all the information is not necessarily needed. In particular, depending on setting, even in the case of the same user, there may be a case where help information is checked repeatedly. In such a case, it will take time to arrive at necessary information for every time. Accordingly, a load on a user to arrive at necessary information has become large.

The present invention has been achieved in view of the above-mentioned circumstances, and an object of the present invention is to provide an information processing apparatus that can evaluate a help screen appropriately.

In order to realize the above-described object, an information processing apparatus that reflects one aspect of the present invention, includes an operation display that displays an operation screen with regard to setting of a job and receives an operation by a user through the operation screen; a memory unit that memorizes the operation screen and a plurality of help screens to show guidance information with regard to an operation or setting on the operation screen and memorizes by associating the operation screen and at least one of the plurality of help screens; a determiner that, in a case where the operation display has displayed a help screen of the plurality of help screens and thereafter has received execution start of a job corresponding to the operation screen associated with the help screen, determines usefulness of the help screen by executing a first determination to determine whether or not a setting content of the job and a content of the help screen coincide; and a provider that provides an identifier indicating as being useful guidance information to the help screen for which the determiner has determined that a determination result of the first determination is “Yes” and makes the memory unit memorize the help screen.

In order to realize the above-described object, a non-transitory recording medium storing a computer-readable control program that reflects one aspect of the present invention, is executed in an information processing apparatus including an operation display that displays an operation screen with regard to setting of a job and receives an operation by a user through the operation screen and a memory unit that memorizes the operation screen and a plurality of help screens to show guidance information with regard to an operation or setting on the operation screen and memorizes by associating the operation screen and at least one of the plurality of help screens, and is adapted to make a computer execute processing, the processing includes executing, as determination of usefulness, a first determination that determines whether or not a setting content of a job and a content of a help screen coincide in a case of having displayed the help screen on the operation display and thereafter having received execution start of the job corresponding to the operation screen associated with the help screen; providing an identifier indicating as being useful guidance information to the help screen determined as being “Yes” in a determination result of the first determination; and making the memory unit memorize this matter.

In order to realize the above-described object, a control method that reflects one aspect of the present invention and is executed in an information processing apparatus including an operation display that displays an operation screen with regard to setting of a job and receives an operation by a user through the operation screen and a memory unit that memorizes the operation screen and a plurality of help screens to show guidance information with regard to an operation or setting on the operation screen and memorizes by associating the operation screen and at least one of the plurality of help screens, the control method includes: executing, as determination of usefulness, a first determination that determines whether or not a setting content of a job and a content of a help screen coincide in a case of having displayed the help screen on the operation display and thereafter having received execution start of the job corresponding to the operation screen associated with the help screen; providing an identifier indicating as being useful guidance information to the help screen determined as being “Yes” in a determination result of the first determination; and making the memory unit memorize this matter.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a drawing showing a schematic configuration of an image processing apparatus according to the present embodiment.

FIG. 2 is a block diagram showing a hardware constitution of an image processing apparatus.

FIG. 3 is a drawing showing a schematic configuration of an image processing apparatus according to the other embodiment.

FIG. 4 is a functional block diagram showing a function of a processor of an image processing apparatus.

FIG. 5 is a flowchart showing usefulness determination processing of a help screen that an image processing apparatus executes.

FIG. 6 shows an example of an operation screen for setting.

FIG. 7 shows an example of a help screen.

FIG. 8 shows a correspondence table showing an outline of each help screen and a keyword corresponding to each of them.

FIG. 9 shows a screen example showing a part of pages of a help screen B.

FIG. 10 shows a screen example showing a part of pages of a help screen F.

FIG. 11 shows a screen example showing a part of pages of a help screen J.

FIG. 12 is a flowchart showing usefulness determination processing of a help screen in the second embodiment.

FIG. 13 is a flowchart showing usefulness determination processing of a help screen in the third embodiment.

FIG. 14 is a flowchart showing utilization processing of historical data of a usefulness determination result.

FIG. 15 shows an example of an operation screen to which a link button is added.

FIG. 16 shows an example of a help screen of a link destination.

FIG. 17 is a flowchart showing usefulness determination processing of a help screen in the fourth embodiment.

### DETAILED DESCRIPTION OF EMBODIMENTS

Hereinafter, with reference to attached drawings, an embodiment of the present invention will be described. However, the scope of the invention is not limited to the disclosed embodiments. In this connection, in the description for the drawings, the same element is provided with the same reference symbol, and the overlapping description is omitted. Moreover, dimensional ratios in the drawings are exaggerated on account of description and may be different from the actual ratios.

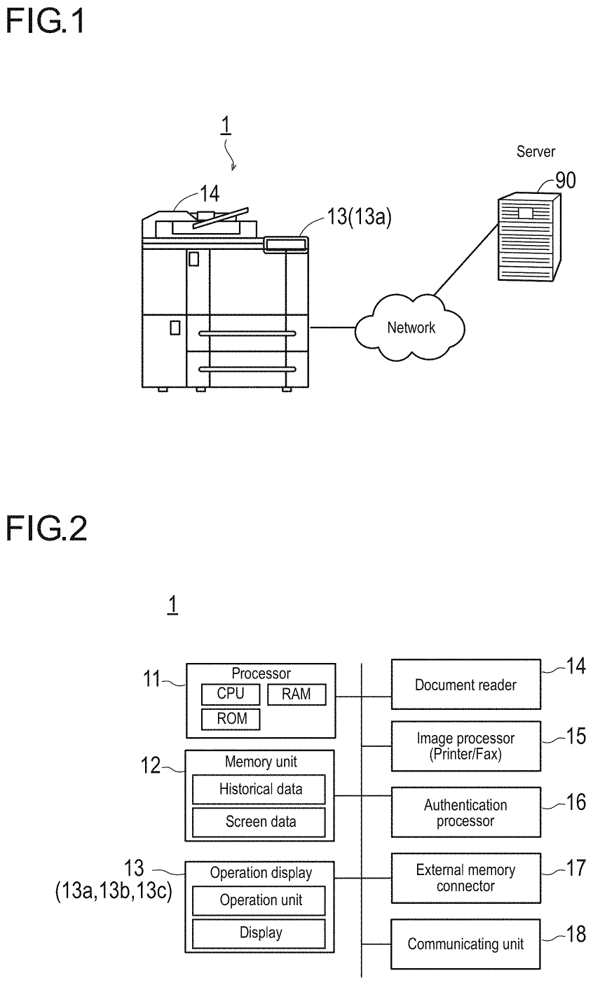

FIG. 1 is a drawing showing a schematic configuration of an image processing apparatus according to one embodiment of the present invention. FIG. 2 is a block diagram showing a hardware configuration of an image processing apparatus system. As a practical example described below, description is made on the basis of an example of a case where an information processing apparatus is an image processing apparatus that performs image processing with respect to image data, especially, image data (read image data) obtained by reading a document. However, without being limited to this example, the information processing apparatus may be an apparatus that operates on a PC and performs processing with respect to a certain job.

As shown in FIG. 1, the image processing apparatus 1 is connected to an external server 90 through a network. The image processing apparatus 1 determines the usefulness of a help screen with usefulness determination processing mentioned later. Moreover, the image processing apparatus 1 transmits periodically the historical data of determined usefulness determination results to a server 90 registered beforehand

(Image Processing Apparatus 1)

As shown in FIG. 2, the image processing apparatus 1 includes a processor 11, a memory unit 12, an operation display 13, a document reader 14, an image processor 15, an authentication processor 16, an external memory connector 17, and a communicating unit 18, and these devices are mutually connected through buses for exchanging signals.

(Processor 11, Memory Unit 12)

The processor 11 includes a CPU, a RAM, and a ROM. The processor 11 performs control for each of units and devices and various kinds of arithmetic processing including usefulness determination processing in accordance with programs memorized in the ROM and the memory unit 12. The memory unit 12 includes a semiconductor recording body that stores various kinds of programs and various kinds of data in advance and a magnetic recording body, such as a hard disk.

The memory unit 12 memorizes image data that relates to an operation screen across a plurality of hierarchies and a plurality of pages to be displayed on the operation display 13 and a plurality of help screens with respect to setting items of the operation screen. On the operation screen, the setting of a job is performed. The help screen is a screen that indicates guidance information (commentary) with regard to operation or setting. Moreover, among the plurality of help screens, almost all the help screens include image data across a plurality of pages. Here, the page represents a range displayed at once on a region of the display screen of the operation display 13. In the present embodiment, a help screen to be displayed on the display screen of the operation display 13 can be switched one after another in units of pages. However, it may be permissible to make the help screen to be able to be scrolled steplessly (not in units of pages).

Moreover, the memory unit 12 memorizes identifiers relative to help screens as historical data and further memorizes historical data (management table) that describes correspondence with an operation screen. These identifiers include a useful tag and a useless tag.

(Operation Display 13)

The operation display 13 includes a touch panel, a ten key, a start button, a stop button, a help button, and the like. The operation display displays a state of the image processing apparatus 1 and receives various kinds of settings and input of operation by a user. Moreover, the operation display displays a help screen in the case where a user performs the various kinds of settings.

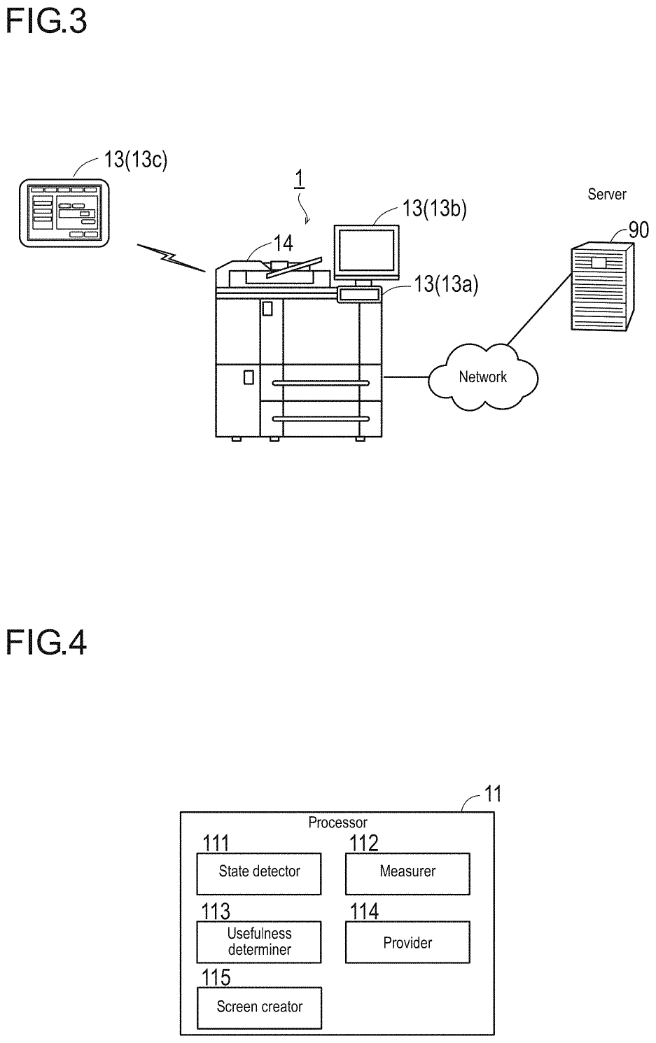

In an example shown in FIG. 1, the operation display 13 is one structural component disposed on an upper portion on the front side of the main body of the image processing apparatus 1. However, a plurality of operation display 13 may be used. FIG. 3 is a drawing showing a schematic configuration of an image processing apparatus 1 according to other embodiment. For example, as shown in FIG. 3, together with an operation display 13a disposed on an upper portion on the front side of the main body or, in place of the operation display 13a, an operation display 13b of a large size may be used. In this case, an operation screen is displayed on the operation display 13a, and then, it may be permissible to make a help screen to be displayed on another operation display 13b used as a sub screen by pressing down a help button from this operation scree. Moreover, a portable or mobile type device such as a smart phone, a tablet terminal, etc. may be used together as the operation display 13c. The operation display 13c includes a wireless communicating unit, displays screen data sent from the communicating unit 18, and further, transmits information on a touch position by a user on an operation screen to the main body side of the image processing apparatus 1. The processor 11 of the image processing apparatus 1 transmits the next image data corresponding to a touch position to the operation display 13c. For example, on the operation display 13c, in response to an operation of a user for an operation screen, a help screen sent from the main body side is displayed. In the following portion, these operation displays 13a to 13c are collectively referred to as an operation display 13.

(Document Reader 14)

The document reader 14 includes an ADF (Automatic Document Feeder) and a reading unit. The ADF conveys a document placed on a document placing stand to a reading position. Moreover, the document reader 14 includes a sensor that detects that a document sheet has been set on the document placing stand. On the basis of output of this sensor, the image processing apparatus 1 detects a loading operation to load a document sheet onto a document placing stand by a user and a removing operation (conducted by cancellation). The reading unit includes a sensor array, a lens optical system, an LED (Light Emitting Diode) light source, and so on. The sensor array is a color line sensor in which a plurality of optical elements (for example, CCD (Charge Coupled Device)) are disposed along a main scanning direction in a form of a line. The optical system includes a plurality of mirrors and a lens. The reading unit is configured to read out a document sheet conveyed to a reading position by the ADF, whereby read image data is generated.

(Image Processor 15)

The image processor 15 includes a printer and a FAX unit. The printer includes a print controller function and a print function. The print controller function is configured to perform layout processing and rasterization processing for print data included in a print job received from the communicating unit 18 or read image data generated by the document reader 14, thereby creating image data that is data of an image in a bit map format. The print function is configured to perform image formation for a paper sheet on the basis of the created image data by an electrophotographying system and the like. The FAX unit includes a modem and the like and performs sending and receiving data with external terminals by being connected through telephone lines to telephone line networks such as public lines and private branch exchanges.

(Authentication Processor 16)

The authentication processor 16 performs login authentication processing by comparing user ID and password information input by a user from the operation display 13 with authentication data. Alternatively, the authentication processor 16 performs login authentication processing by comparing data generated by scanning ID information on an ID card owned by a user with a reader (not shown) of a near field communication system provided on a main body of the image processing apparatus 1, with authentication data. In this connection, the authentication data may be administrated by the image processing apparatus 1, or it may be permissible to make the other external server used for authentication administrate the authentication data. In the latter case, on the basis of authentication information input by a user, whether or not to authenticate is determined on the external server side, and the image processing apparatus 1 is configured to receive an authentication result.

(External Memory Connector 17)

The external memory connector 17 includes connection ports and functions as an interface for communicating with portable type memories, such as a USB memory and an SD card. A user can execute jobs, such as print and FAX by using file data, such as a word file and image data, memorized in the portable type memories.

(Communicating Unit 18)

The communicating unit 18 functions as an interface for allowing the image processing apparatus 1 to communicate with external devices, such as the server 90, a PC and the like. In the communicating unit 18, usable are various kinds of local connection interfaces, such as a network interface according to standards, such as SATA, PCI, USB, Ethernet (registered trademark), and IEEE1394 and a wireless communication interface, such as Bluetooth (registered trademark) and IEEE802.11. The communicating unit 18 functions as an output unit by cooperating with the processor 11. In concrete terms, the processor 11 extracts combination information of a help screen provided with a useless tag and an operation screen made to correspond to this help screen from the memory unit 12. Successively, the communicating unit 18 transmits the extracted combination information to an external server.

(Function of Processor 11)

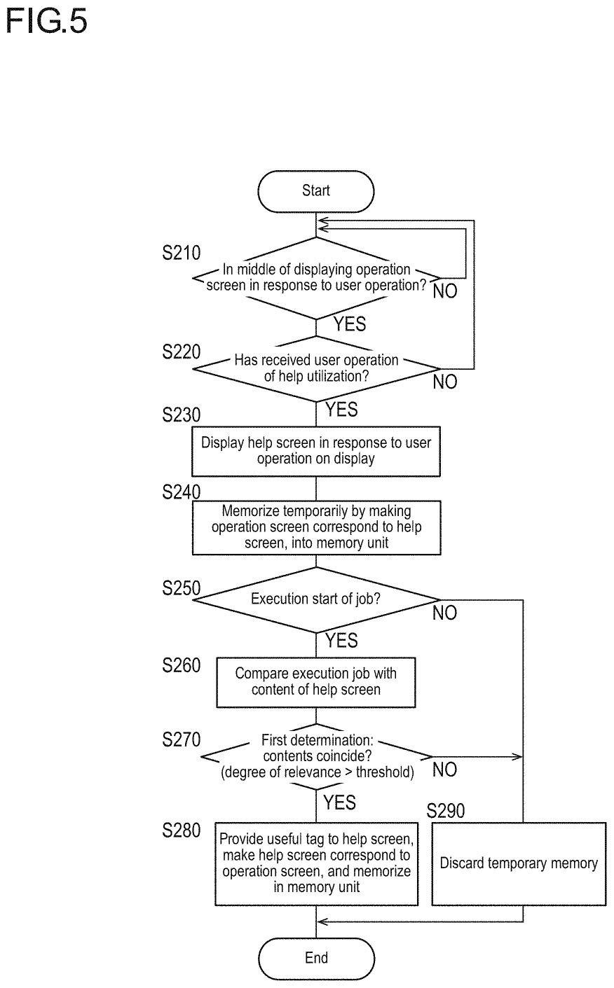

FIG. 4 is a functional block diagram showing the functions of the processor 11 of the image processing apparatus 1. As shown in FIG. 4, the processor 11 functions as a state detector 111, a measurer 112, a usefulness determiner 113 (determiner), a provider 114, and a screen creator 115.

(State Detector 111)

The state detector 111 determines a state of the image processing apparatus 1 through various kinds of sensors. In concrete terms, the state detector 111 determines that the state is a state where a preliminarily notifying operation with regard to execution start of a job has been detected (hereinafter, merely referred to as a “preliminarily-notified state”), or a state where this preliminarily notifying operation has been cancelled (hereinafter, merely referred to as a “canceled state”). Examples of the preliminarily notifying operation include, for example, the following (1) to (4).

(1) In the case where the image processing apparatus 1 is connected to a coin vendor (not shown) provided with a coin throwing port and a returning button, and in the case where coins of a predetermined money amount or more have been thrown into the coin throwing port, the state detector 111 determines that the state is a preliminarily-notified state. Moreover, in the case where coins have been returned by an operation for the return button by a user without performing any of jobs involving payment of coins, the state detector 111 determines that the state is a canceled state.
(2) Moreover, after a user has gone out to the image processing apparatus 1, has performed authentication with the authentication processor 16, and has established a logged-in state, in the case where service usage permission for a certain job has been given to the login user, the state detector 111 determines that the state is a preliminarily-notified state. Moreover, in the case where any of jobs provided with usage permission have been logged off (cancelling operation for an authenticated state) without being executed, the state detector 111 determines that the state is a cancelled state.
(3) In the case where a loading operation for a document sheet by a user in the ADF of the document reader 14, has been detected, the state detector 111 determines that the state is a preliminarily-notified state. Moreover, in the case where this document sheet has been removed without performing reading, the state detector 111 determines that the state is a canceled state.
(4) In the case where the external memory connector 17 detects the connection (attaching) of a portable memory (connecting operation), the state detector 111 determines that the state is a preliminarily-notified state. Moreover, in the case where the portable memory has been detached without performing any of jobs expected to use file data in the portable memory (detaching operation), the state detector 111 determines that the state is a canceled state.

(Measurer 112)

The measurer 112 includes a timer function and measures the elapsed time of each processing. In concrete terms, the measurer 112 measures the display time of a help screen and records this. This measurement may be performed for each help screen or may be performed for each page of a help screen or for each display region smaller than each page.

(Usefulness Determiner 113)

The usefulness determiner 113 determines whether there is usefulness or uselessness in a help screen. In the case where a help screen is useful guidance information, the usefulness determiner 113 determines that the help screen is useful, and in the case where a help screen is useless guidance information, the usefulness determiner 113 determines that the help screen is useless. In order to make it easy to access a useful help screen determined in this determination result, a link button to access the concerned help screen is created automatically, or the hierarchy of the concerned help screen is changed to a higher order. Moreover, a useless help screen is utilized to improve the help screen itself by allowing an administrator (developer) to utilize its information.

(1. Usefulness)

The usefulness determiner 113 performs the following first to third determinations as determination of “usefulness”. In this connection, all the first to third determinations are need not to be necessarily performed. Accordingly, the third determination or the second and third determinations may be omitted.

(i) In the first determination, after a help screen has been displayed on the display surface of the operation display 13, in the case where a request of execution start of a job corresponding to an operation screen associated with the help screen has been received, it is determined whether or not the content of setting of the job and the content of the help screen coincide with each other. In this determination, keywords provided in advance to the whole or each page of the help screen and keywords representing the content of the executed job are compared with each other. As a result, in the case where all or a part of the keywords are common, it is determined that both parties coincide with each other. In the case where both parties coincide with each other, when the help screen executes the job, it is determined as being useful. Herein, the job means a job with regard to, for example, image processing. Examples of the job with regard to image processing, include a print job that prints image data on a sheet, a scan job that reads out a document sheet and generates read image data, a transmission job that FAX-transmits or E-mail-transmits this read image data or image data memorized in a designated folder, and the like.
(ii) In the second determination, it is determined whether or not a stopping operation for the job being executed has been received through the operation display 13 after an instruction of execution start with regard to the above job has been received, or it is determined whether or not a deleting operation for the deliverables (for example, the read image data of the scan job) of this job has been received through the operation display 13 within a predetermined period after the job has been completed. The predetermined period is, for example, within from several seconds to several minutes after the job has been completed.
(iii) In the third determination, it is determined whether or not a help screen provided with a useful tag has been displayed again within a predetermined period after the job has been completed. The providing of this useful tag is performed by the first determination or the first and second determinations.

(2. Uselessness)

Moreover, the usefulness determiner 113 also performs the determination of “uselessness” indicting as being useless guidance information. After a preliminarily-notified state has been detected by the state detector 111, in the case where a canceled state has been detected, help screens having been displayed during a period between the detection of the preliminarily-notified state and the detection of the canceled state are determined as being useless.

(Provider 114)

The provider 114 provides a useful tag indicating as being useful guidance information to a help screen determined as being useful by a determination result of at least one of the first to third determinations by the usefulness determiner 113 and makes the memory unit 12 memorize this matter. Moreover, the provider 114 provides a useless tag indicating as being useless guidance information to a help screen determined as being useless by the usefulness determiner 113 and makes the memory unit 12 memorize this matter. At this time, together with the useful tag or useless tag, it may be permissible to make the original operation screen having caused the shifting to the help screen, correspond to the help screen and to memorize this matter in the memory unit 12. Moreover, further, together with the useful tag or useless tag, it may be permissible to associate user information having instructed execution of the job with the help screen and to memorize this matter in the memory unit 12. The user information is, for example, a user ID of a logged-in user to which authentication has been performed by the authentication processor 16.

It may be permissible to provide a useful tag or a useless tag to a page of a help screen. For example, the usefulness determiner 113 compares the content of a page of a help screen having been referred (displayed for browsing) by a user with the content of a job in units of a page and provides a useful tag to a page with the highest relevance (“most relevance-based method”). Alternatively, a page to be provided with a useful tag may be determined by a “latest reference based method” or a “longest reference based method”. In the latest reference-based method, in the case of having referred to a plurality of pages or a plurality of help screens, a useful tag is provided to a page of a help screen that has been referred immediately (lastly) before a job is executed. In the longest reference-based method, a measurer 112 is configured to measure the display time during which each page has been referred, and then a page having been referred for the longest time is selected, and a useful tag is provided to this page. In this longest reference-based method, for each time when one job has been executed, the counter value of a display time is reset. Moreover, in the case where a plurality of help screens have been referred to by a user, the display times of respective pages of the plurality of help screens are compared with each other.

(Screen Creator 115)

The screen creator 115 creates an operation screen in which a link button to shift to a help screen on the basis of a useful tag is arranged. In concrete terms, a new operation screen is created by synthesizing a link button and a link for an original operation screen. The synthesizing of the link is performed by a well-known technique. For example, the link is synthesized in a character on an operation screen, and then, this synthesized character is provided with an under line and is subjected to color-coding, whereby the link is made in a mode is made so as to be distinguished from other portion.

(Usefulness Determination Processing in First Embodiment)

Next, description is given to usefulness determination processing performed in the image processing apparatus 1 with reference to FIG. 5 to FIG. 11. FIG. 5 is a flowchart showing the usefulness determination processing for a help screen.

(Step S210)

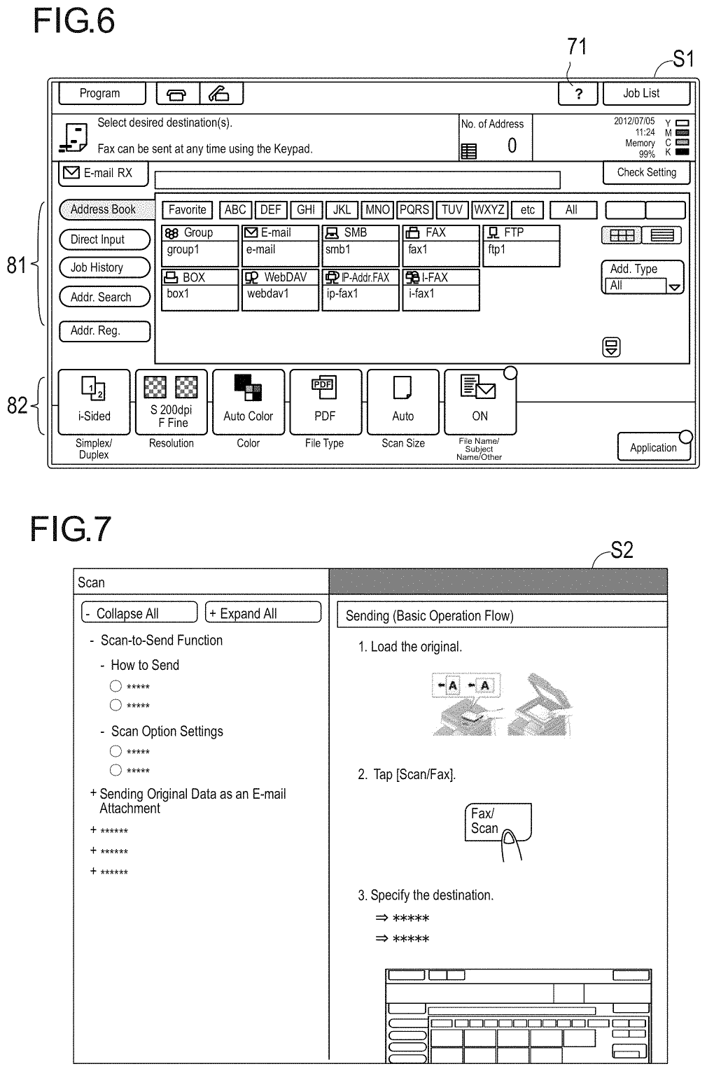

The processor 11 determines whether or not an operation screen in response to a user operation is being displayed. FIG. 6 shows an example of an operation screen for setting with regard to a transmission job that transmits read image data generated by reading by the document reader 14. This operation screen 51 is memorized in the memory unit 12 and is displayed on, for example, the operation display 13a (refer to FIG. 3). On the operation screen 51, a user can set a transmission destination through each button on a column 81 at a middle stage and can perform condition setting of read image data to be generated from a document sheet through a column 82 at a lower stage. After having completed the setting, a user can perform a start instruction of a job by depressing a start button (hard key (not shown)). In the case where the operation screen 51 as shown in FIG. 6 is in middle of being displayed (YES), the processing is advanced to Step S220.

(Step S220)

In the case of having received an operation for utilizing a help (YES), the processor 11 advances the processing to Step S230. In concrete terms, the above case is a case where a help button 71 (or a help button (a hard key (not shown) disposed outside a screen (not shown)) on the operation screen 51 is depressed by a user.

(Step S230)

Here, in response to the processing in Step S220, the processor 11 changes (shift) the display content of the operation display 13 to a help screen, or displays a help screen on a sub screen. FIG. 7 shows an example of the help screen. This help screen S2 is a general-purpose help screen, unlike a help screen configured to shift in response to a latter-mentioned link button, and, for example, is a help screen disposed at a top hierarchy. The content of this help screen S2 does not correspond directly to an operation screen, but a certain content is always displayed. This help screen S2 is memorized in the memory unit 12. For example, the operation screen 51 is displayed on the main operation display 13a, and the help screen S2 is displayed on a sub operation display 13b (refer to FIG. 3).

(Step S240)

The processor 11 temporarily memorizes the correspondence relation information that makes the operation screen having been displayed in Step S220 correspond to the help screen having been displayed in Step S230, in the memory unit 12 and the like. This correspondence relation information may be made by performing the corresponding in units of a help screen, or, in the case where a help screen is constituted by a plurality of pages, the correspondence relation information may be made by performing the corresponding in units of a page.

(Step S250)

In the case where the processor 11 has received an instruction of execution start of a job (YES), the processing is advanced to Step S260. In concrete terms, the above case is a case where a user has depressed a start button. On the other hand, even if a predetermined period (from several seconds to several minutes) has elapsed, in the case where the processor 11 has not received an instruction of execution start (NO), the processing is advanced to Step S290.

(Steps S260 and S270)

The usefulness determiner 113 performs the first determination. In this first determination, the usefulness determiner 113 compares the content (content of setting) of a job for which the execution has been started in Step S250, with the content of the help screen that has been displayed on the operation display 13 and referred by a user in Step S230. This comparison may be performed by comparing the degree of similarity between keywords indicating the content of the job and wording of the description described on the help screen, or by comparing keywords that have been provided to a help screen in advance as described below and keywords of a job.

(Comparison of Job and Help Screen)

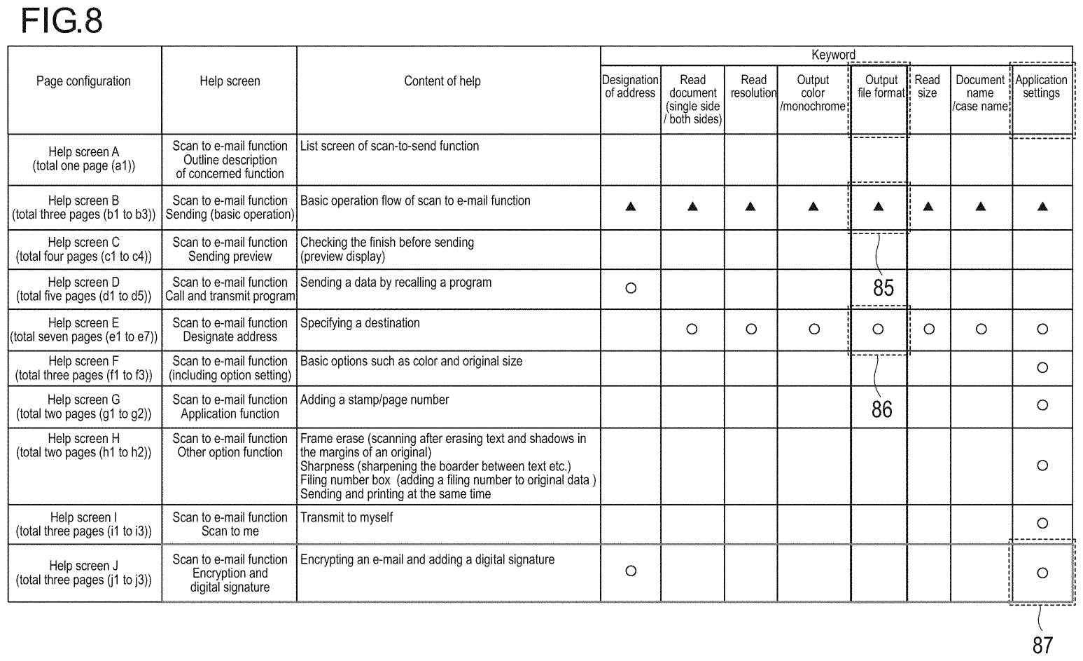

FIG. 8 is a correspondence table showing an outline of each of help screens and a keyword corresponding to each of them. FIG. 8 is a list of help screens A to J with a plurality of items with regard to setting of a Scan to E-mail function as a transmission job. In a column of “page configuration”, the total number of pages of each of the help screens is described, and in a column of “help screen” and a column of “content of help”, a title of a help screen and a content of help are indicated, respectively. Moreover, in a column of “keyword”, whether or not a content corresponds to one of keyworks, is indicated. In the case where a column of “keyword” shows “▴” or “◯”, it indicates that a content corresponds to a keyword marked with “▴” or “◯”. Moreover, “▴” indicates that there is a link directed to another help screen.

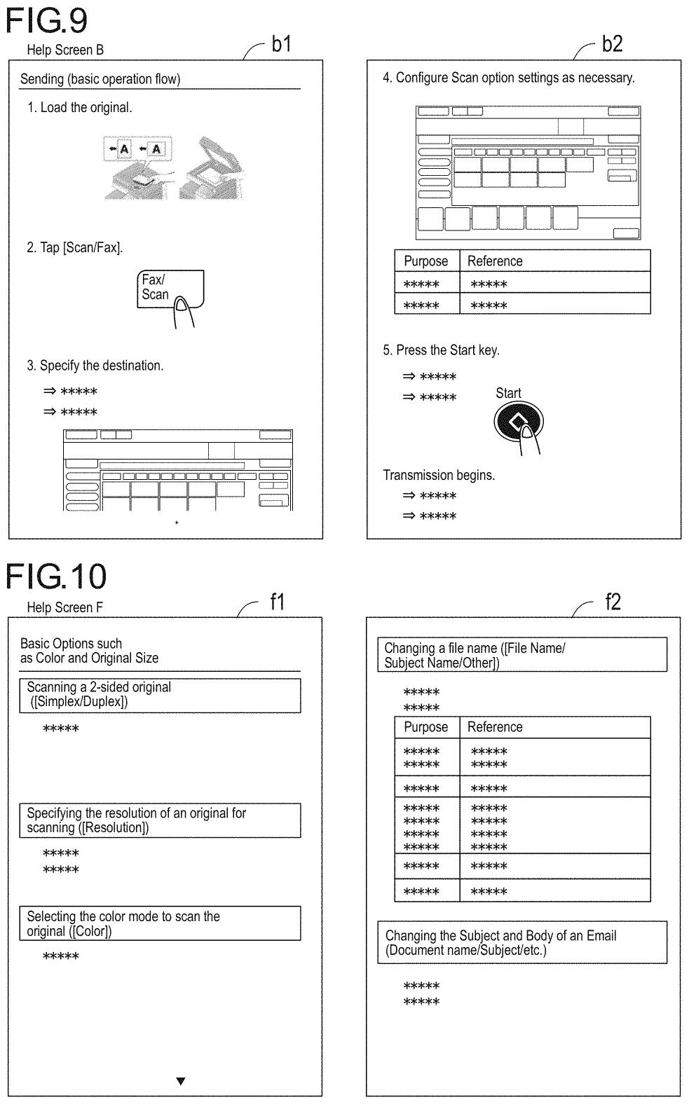

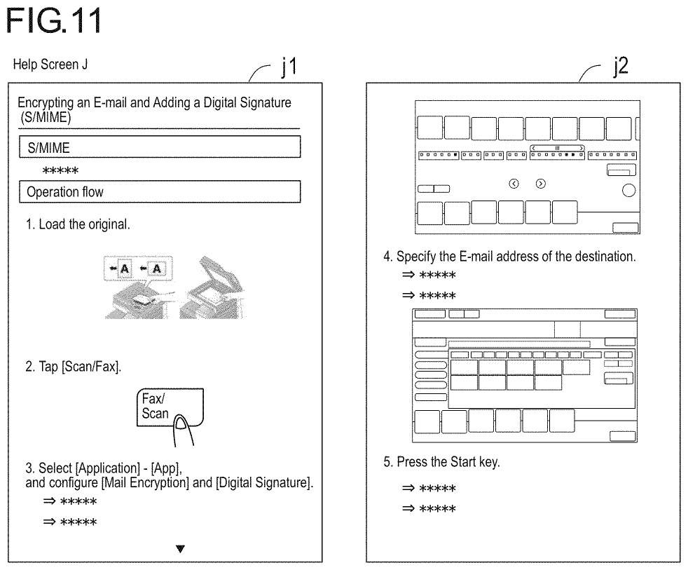

FIG. 9 shows a screen example showing some pages of the help screen B. As shown in FIG. 8, the help screen B is constituted by 3 pages in total, and in FIG. 9, only the first 2 pages (b1, b2) of them are exemplified. FIG. 10 shows a screen examples showing some pages of the help screen F. In FIG. 10, only the first 2 pages (f1, f2) of the help screen F constituted by 3 pages in total are exemplified. Similarly, in FIG. 11, only the first 2 pages (j1, j2) of the help screen J constituted by 3 pages in total are exemplified.

For example, as a transmission job, a job (hereinafter, referred to as an “encrypted PDF transmission job”) is assumed that encrypts a transmission job by a Scan to E-mail function and designates a PDF format as a file format at that time. In this case, the content of the job corresponds to “output file format” and “application setting (encryption)”. In this case, in the case where any of the help screens B, F, and J corresponding to the keywords indicated with signs 85 to 87 in FIG. 8 is referred to, the usefulness determiner 113 determines that the contents coincide (S270: YES). In this case, the processing is advanced to Step S280. On the other hand, in the case where the usefulness determiner 113 has determined that the executed job and the content of the referred help screen do not coincide with each other (S270: NO), the processing is advanced to Step S290.

In this connection, as mentioned above, the determination of this usefulness may be performed in units of a page. For example, in the case where the help screen of the page j 1 shown in FIG. 11 is referred to in the case where the “encrypted PDF transmission job” has been executed, the usefulness determiner 113 determines such that the content of the job and the content of the page of the referred help screen coincide with each other (S270: YES).

Moreover, with regard to the determination for the coincidence between the contents in Step S270, in the case where there is a help screen whose score of the degree of relevance relative to the job for which execution has been started is a predetermined value or more, it may be permissible to determine that the contents coincide with each other. In the calculation of this score, the content of the job is compared with a keyword provided beforehand to each page of the help screen, and then, the degree of relevance is calculated based on the height in each of the degree of coincidence and the degree of similarity of words.

(Step S280)

The provider 114 provides a useful tag to a help screen, makes the help screen correspond to an operation screen, and makes the memory unit 12 memorize this matter. The providing of the useful tag may be performed in units of a page. In this case, the selection of a page to be provided with a useful tag from a plurality of pages constituting a help screen having been determined such that the contents coincide with each other, may be performed by the above mentioned “most relevance-based method”, “latest reference based method”, or “longest reference-based method”. In the “most relevance-based method”, a page whose score in the degree of relevance between the content of a job and keywords is highest is selected, in the “latest reference-based method”, a page having been referred to at the last is selected, and in the longest reference-based method, a page having been referred to for the longest time is selected. The correspondence information having been memorized here includes information on an operation screen that has received an operation for referring (for displaying by shifting) to the help screen provided with the useful tag.

(Step S290)

In here, the provider 114 discards the correspondence that has been memorized temporarily in Step S240, due to the reason that the job has not been executed, or that the job having been executed and the content of the help screen do not coincide with each other. In this connection, this discard may not be performed at this timing, and may be performed after a predetermined period (for example, several hours) has elapsed, or at a timing when the power source of the image processing apparatus 1 has been turned OFF or ON.

In this way, in the image processing apparatus according to the first embodiment, as the determination of usefulness, in the case where a help screen is displayed on an operation display and then an instruction of execution start of a job corresponding to the operation screen associated with the help screen has been received, the first determination that determines whether or not the content of the job and the content of the help screen coincide with each other, is executed. Successively, a useful tag is provided to the help screen determined as being “Yes” in a determination result of the first determination, and a memory unit is made to memorize this matter. By doing in this way, evaluation for a help screen can be performed appropriately. Moreover, on a basis of a fact that a user was able to actually set and execute a job, or a fact that the user was not able to execute, the evaluation for the help screen that the user has used can be appropriately performed. Subsequently, by memorizing the evaluation, when a user calls a help screen in order to perform similar settings on the setting screen of a job, the user can arrive at necessary information easily, whereby it is possible to enhance the efficiency of job setting.

(Usefulness Determination Processing in Second Embodiment)

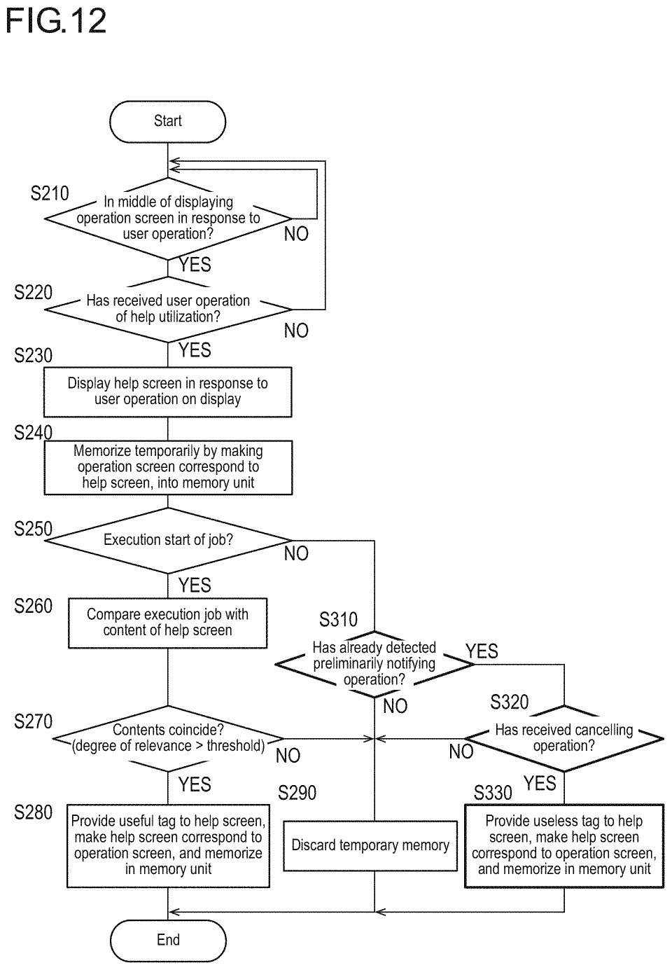

FIG. 12 is a flow chart showing the usefulness determination processing for a help screen executed by the image processing apparatus 1 in the second embodiment. In the second embodiment shown below, together with the providing of a useful tag performed in the first embodiment, as the usefulness determination processing, a useless tag is provided as useless (improvement-required) guidance information indicating that a help screen is not helpful. In FIG. 12, since Steps S210 to S290 are the same processing as those in the first embodiment shown in FIG. 5, the descriptions are omitted.

(Step S310)

It is determined whether the state detector 111 has detected a preliminarily notifying operation. This preliminarily notifying operation includes, as mentioned above, by a user, (1) a coin throwing operation to throw coins to a coin vendor, (2) a login operation for obtaining an authority to use a service of job execution by the image processing apparatus 1, (3) a loading operation to load a document sheet to an ADF of the document reader 14, or (4) a connecting operation to connect a portable memory to the external memory connector 17. In many cases, the preliminarily notifying operation is executed, for example, at a time point before Step S210. In the case of having detected a preliminarily notifying operation (YES), the processor 11 advances the processing to Step S320. On the other hand, in the case of having not detected a preliminarily notifying operation (NO), the processing is advanced to Step S290.

(Step S320)

With regard to the preliminarily notifying operation determined as having been detected in Step S310, the state detector 111 determines whether or not a cancelling operation to make this a canceled state has been received from the user. As an example of a preliminarily notifying operation, if a preliminarily notifying operation to load a document sheet on the ADF in the above (3) is cited, in a case of having detected that the document sheet has been removed from the ADF, the state detector 111 determines that a cancelling operation has been received. In the case where the cancelling operation has been received (YES), the processor 11 advances the processing to Step S330. On the other hand, in the case where the cancelling operation has not been received (NO), the processing is advanced to Step S290.

(Step S330)

The provider 114 provides a help screen with a useless tag indicating that an improvement is required, makes the help screen correspond to the operation screen, and makes the memory unit 12 memorize this matter. The providing of this useless tag may be performed in units of a page. In this case, the selection of a page to be provided with a useless tag may be performed by the above mentioned “most relevance-based method”, “latest reference-based method”, or “longest reference-based method”. The correspondence information memorized here includes information on an operation screen that has received an operation for referring (for displaying by shifting) to the help screen provided with the useless tag.

In this way, in the image processing apparatus according to the second embodiment, by determining usefulness, the same effect as that in the first embodiment can be acquired, and in addition, in the case where the state detector 111 detects the cancellation of a preliminarily notifying operation in a state that a job has not been executed after the preliminarily notifying operation has been detected, the determination has been made such that it is useless, and a useless tag is provided to the help screen. With this, the evaluation of the help screen can be performed properly from various perspectives.

(Usefulness Determination Processing in Third Embodiment)

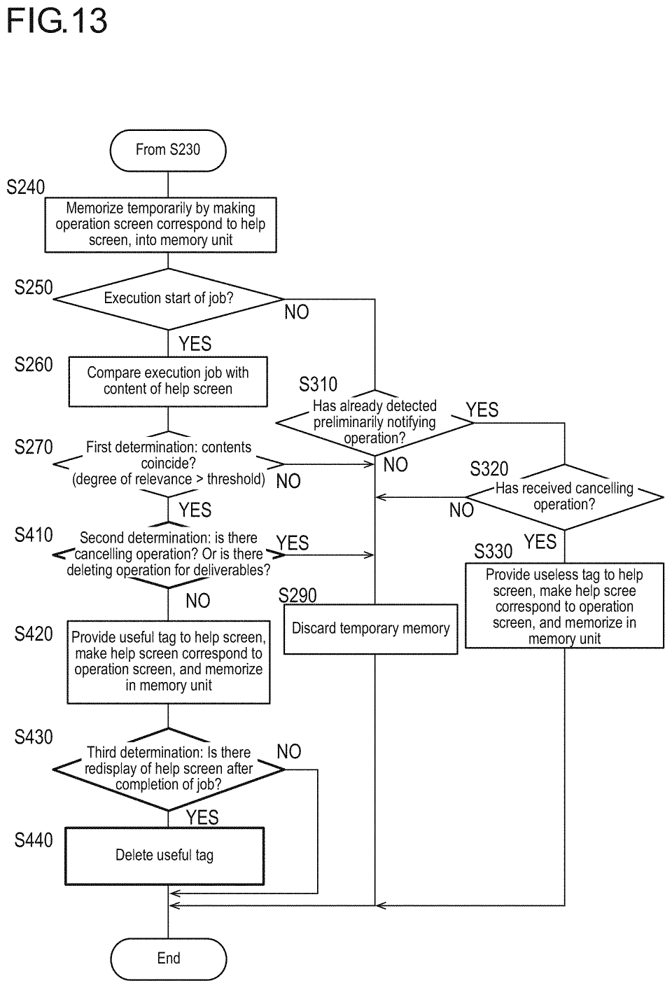

FIG. 13 is a flowchart showing the usefulness determination processing of a help screen that the image processing apparatus 1 executed in the third embodiment. In the third embodiment shown below, in addition to the first determination (determination for coincidence between contents) having been performed in the first and second embodiments, the second and third determinations are performed. FIG. 13 shows processing performed in succession to Step S230 shown in FIG. 12. Moreover, in FIG. 13, since Steps S240 to S290 and Steps S310 to S330 are the same processing as those in the second embodiment described in FIG. 12, the descriptions are omitted.

(Step S410)

The usefulness determiner 113 performs the second determination. In this second determination, with regard to a job for which execution has been started in Step S250, the usefulness determiner 113 determines whether or not a cancelling operation has been made in middle of the execution, or whether or not deletion processing for deliverables has been performed within a predetermined period (for example, from several seconds to several minutes or less) after the execution has been completed. For example, in the case where a user checks a finished state (printed matter) in the middle of execution of a print job and then notices that deliverables different from the intended finished state are being output, the user may cancel (stopping operation) the print job. In the case of having cancelled, the print job in the middle of execution is interrupted or stopped. Moreover, as another example, after a user has completed execution of a scan job, in the case where the user notices that deliverables (read image data) are different from an intended file format or intended resolution, the user may delete the deliverables. In the case of having received such cancellation or deletion instruction for deliverables (YES), the usefulness determiner 113 advances the processing to Step S290. On the other hand, in the case of having not received them (NO), the usefulness determiner 113 advances the processing to Step S420.

(Step S420)

Here, the provider 114 performs the similar processing to that in Step S280 shown in FIG. 12 and the like. In concrete terms, the provider 114 provides a useful tag to a help screen and makes the memory unit 12 memorize this matter.

(Step S430)

The usefulness determiner 113 performs the third determination. In this third determination, the usefulness determiner 113 determines whether or not the help screen provided with a useful tag in Step S420 has been redisplayed within a predetermined period (for example, from several seconds to several minutes or less) after the job for which execution has been started in Step S250, has been completed. For example, after a user has executed a transmission job to transmit a document through a FAX to the respective addresses of two persons, in the case where the user notice that the document has been transmitted only to the address of one person, the user may display again and refer to the help screen. Like in this way, in the case where the help screen has been redisplayed, the usefulness determiner 113 determines that there is redisplay (YES) and advances the processing to Step S440. On the other hand, in the case where the help screen has not been redisplayed, the processing is ended (END). In this connection, in the case where the providing of a useful tag is performed in units of a page in Step S420, in the case where the concerned page is redisplayed, the determination of redisplay determines as being “Yes” (there is redisplay). However, without being limited to this, in the case where the other page of the same help screen is displayed, it may be also permissible to determine as being “Yes”.

(Step S440)

The provider 114 cancels the useful tag provided in Step S420 and discards the data memorized in the memory unit 12.

In this way, in the third embodiment, in addition to the first determination performed in the first embodiment, the second determination and the third determination are further executed in the following ways. In the second determination, it is determined whether or not a stopping operation for a job in the middle of execution has been received or a deleting operation for deliverables of a job has been received within a predetermined period after the job has been completed. In the third determination, it is determined whether or not a help screen provided with a useful tag has been displayed again within a predetermined period after the job has been completed. After the second determination and the third determination have been executed, by adding the determination results of them into consideration, a useful tag is provided or the provided useful tag is reviewed. With this, the evaluation of a help screen can be performed more accurately.

### Modified Example

In the case where the above-mentioned step S410 is “Yes”, a useful tag has not been provided, but it may be permissible to provide a useful tag of a rank 2. For example, in the case where the first determination is “No”, a useful tag is not provided (S290). In the case where the first determination is “Yes” and the second determination is “No”, a first useful tag of a rank 1 is provided in Step S420. In the case where the first determination is “Yes” and the second determination is “Yes”, as additional processing, a second useful tag of a rank 2 whose usefulness is lower than the rank 1 is provided.

(Utilization Processing of Historical Data)

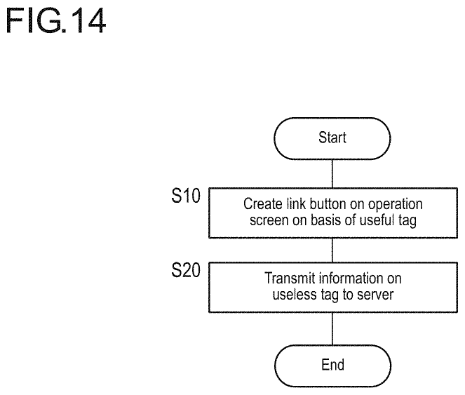

FIG. 14 is a flowchart showing the utilization processing of the historical data of the usefulness determination result of the help screen that the image processing apparatus 1 executes. In the first to third embodiments, from the relationship between a displayed help screen and an executed job, a useful tag or a useless tag is provided to the help screen, and this matter is memorized in the memory unit 12 as historical data. In the utilization processing shown below, by using the historical data, for a useful help screen, to access it is made easy, or for a useless help screen, to improve it is requested.

(Step S10)

The processor 11, refers to the historical data of the memory unit 12, aggregates the correspondence information of useful tags, and determines to nominate a help screen provided with one or more useful tags or a help screen having the scores of a predetermined value or more to a target for which a link button is to be created. Successively, the screen creator 115 creates a new operation screen in which a link button or link for shifting to the help screen that has become the target, is arranged on the operation screen. With regard to a target for which a link button is to be created, a help screen to which one or more useful tags have been provided, may be made a target. Alternatively, the number of provided useful tags is counted for each help screen or for each page of a help screen, and then, in the case where the number of provided useful tags is a specified value or more, it may be made a target. In the case of performing the counting in the latter, and in the case of providing a useful tag of the rank 1 or the rank 2 like the above-mentioned modified example, like a manner that the rank 1 is provided with two points and the rank 2 is provide with one point, it may be permissible to count the number of provided useful tags by weighting with points for each rank.

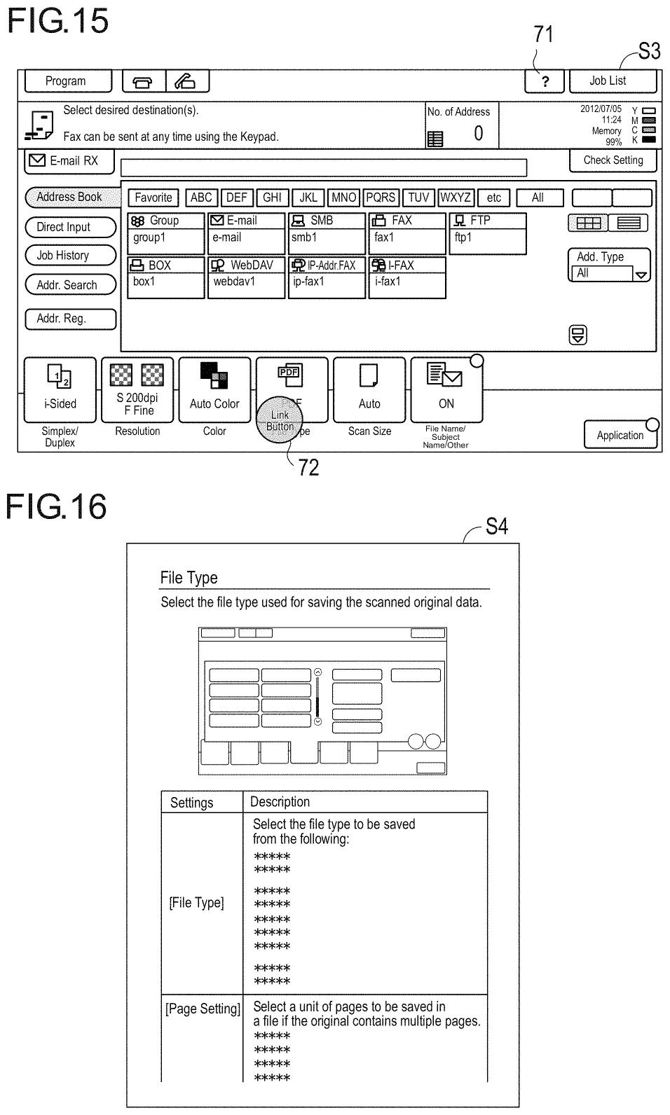

FIG. 15 shows an example of an operation screen to which a link button is added. The screen creator 115 creates a new operation screen S3 in which a link button 72 is added to the operation screen 51 that exists originally in FIG. 6. A user can display a help screen of a link destination shown in FIG. 16 by touching the link button 72 newly arranged on a setting button of “a file format (PDF)” on the operation screen S3. In FIG. 16, a help screen with regard to setting for changing a file format from usual PDF to other file format can be displayed directly. With regard to this, in the case where a general-purpose help button 71 is made to be displayed, it is impossible to reach a desired help screen S4 without passing through a general-purpose help screen S2 as shown in FIG. 7 and further passing through a plurality of hierarchy help screens. As compared with the above case, in the present embodiment, by touching the link button 72, it is possible to reach the help screen S4 directly. With this, it is possible to provide only necessary help information in a manner of pinpoint.

(Step S20)

The processor 11 aggregates the information on the useless tags, extracts combination information (a help screen provided with a useless tag and an operation screen made to correspond to this help screen), and transmits this to the server 90 by using the communicating unit 18. This server 90 is registered beforehand and its transmission destination address is memorized in the memory unit 12. On the server 90 side, the information on the useless tags sent from one or a plurality of image processing apparatuses 1 is aggregated and used to improve the help screen. For example, for a help screen in which the number of useless tags becomes a predetermined number or more, warning is made to ask an administrator (developer) to improve.

In this way, in the present embodiment, by utilizing the historical data of the usefulness determination results, a link button to a help screen can be arranged on an operation screen. With this, since it is possible to reach a useful help screen directly, it is possible to provide only necessary help information in a manner of a pinpoint. Moreover, for useless help screen, it is possible to contemplate an improvement.

(Usefulness Determination Processing in Fourth Embodiment)

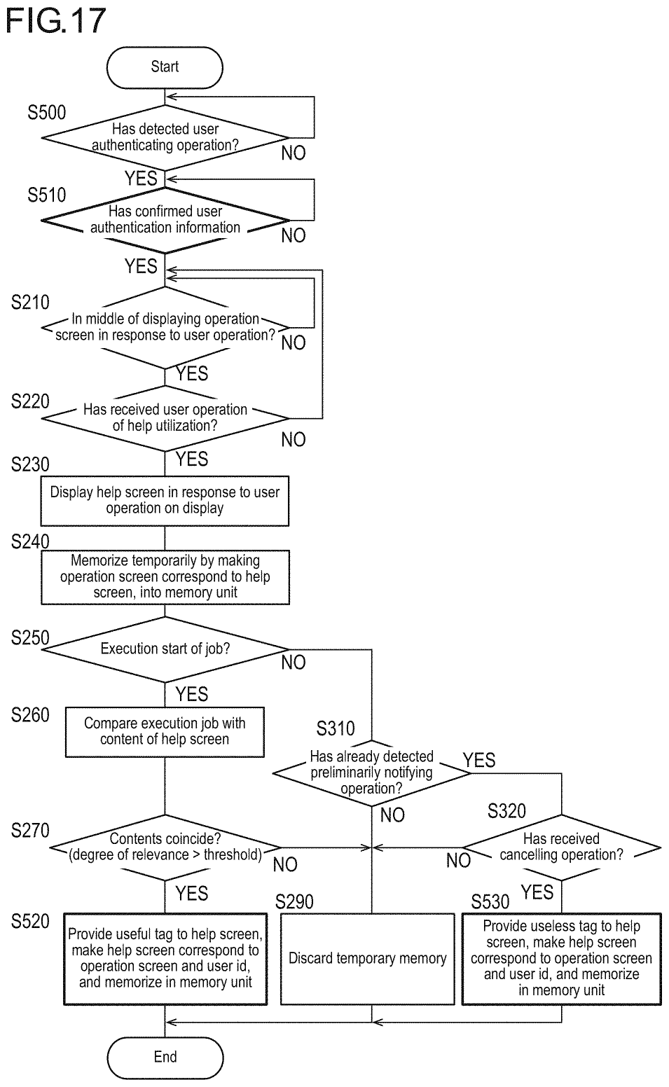

FIG. 17 is a flowchart showing the usefulness determination processing of a help screen that an image processing apparatus executes in the fourth embodiment. In the fourth embodiment shown below, determination of usefulness is made to be performed for each of authenticated users. In FIG. 17, as compared with FIG. 12, Steps S500 to S530 are different. However, the other steps, i.e., Steps S200 to S290 and Steps S310 to S330 are the same processing as those in the second embodiment shown in FIG. 12. Accordingly, the descriptions are omitted.

(Steps S500 and S510)

In the case where authentication information (a user ID, password information, etc.) is input by the authentication processor 16 (S500: YES), next, this authentication information is checked, and then, in the case where login authentication is succeeded (S510: YES), the processing is advanced to Step S210.

(Step S520)

After having performed the processing of Steps S210 to S270, in this step S520, the provider 114 performs the similar processing to Step S280 shown in FIG. 13 and the like. However, unlike Step S280, the user ID is also made to correspond to a help screen, a useful tag, and an operation screen and memorized in the memory unit 12.

(Step S530)

After having performed the processing of Steps S210 to S250 and Steps S310 and S320, in this Step S530, the provider 114 performs the similar processing to Step S330 shown in FIG. 12 and the like. However, unlike Step S330, the user ID (user information) is also made to correspond to a help screen, a useless tag, and an operation screen and memorized in the memory unit 12.

In this way, by providing a user ID, the evaluation of a help screen can be performed more finely. In this connection, the processing of the second determination and the third determination indicated in the processing in FIG. 13 in the above-mentioned third embodiment may be combined with this fourth embodiment. Moreover, the utilization processing of the historical data shown in FIG. 14 may be combined with the fourth embodiment. Namely, the creation of a link button onto an operation screen on the basis of a useful tag is performed for each user ID.

With regard to the configuration of the image processing apparatus 1 or the information processing apparatus, described in the above, its main configuration has been described in order to describe the feature of the above-mentioned embodiment. Accordingly, without being limited to the above configuration, various kinds of modification can be made within the scope of claims. Moreover, a configuration provided in a common information processing apparatus is not intended to be eliminated.

The units and methods configured to perform various kinds of processing in the information processing apparatus according to the embodiments mentioned above can be realized by any of hardware circuits for exclusive use and a programmed computer. The above-mentioned program may be provided by, for example, a computer-readable recording medium, such as a USB memory and a DVD (Digital Versatile Disc)-ROM, or may be provided by on-line through networks, such as internet and the like. In this case, programs recorded in a computer-readable recording medium are usually transmitted to and memorized in a memory unit, such as a hard disk. The present invention relates to an information processing apparatus, a computer-readable recording medium storing a control program, and a control method. Moreover, the above-mentioned programs may be provided as independent application software or may be incorporated in the software of an apparatus as one function of the apparatus.

Although embodiments of the present invention have been described and illustrated in detail, the disclosed embodiments are made for purpose of illustration and example only and not limitation. The scope of the present invention should be interpreted by terms of the appended claims

What is claimed is:

1. An information processing apparatus, comprising:
an operation display that displays an operation screen with regard to setting of a job and receives an operation by a user through the operation screen;
a memory unit that memorizes the operation screen and a plurality of help screens to show guidance information with regard to an operation or setting on the operation screen and memorizes by associating the operation screen and at least one of the plurality of help screens;
a determiner that, in a case where the operation display has displayed a help screen of the plurality of help screens and thereafter has received execution start of a job corresponding to the operation screen associated with the help screen, determines usefulness of the help screen by executing a first determination to determine whether or not a setting content of the job and a content of the help screen coincide; and
a provider that provides an identifier indicating as being useful guidance information to the help screen for which the determiner has determined that a determination result of the first determination is “Yes” and makes the memory unit memorize the help screen.

2. The information processing apparatus according to claim 1, wherein the help screen is a screen across a plurality of pages.

3. The information processing apparatus according to claim 2, wherein the provider provides the identifier as a useful tag.

4. The information processing apparatus according to claim 3, wherein the determiner compares the content of the job with a keyword provided to an entire of the help screen or a page of the help screen, and then, in a case where a degree of relevance between the content of the job and the keyword is a predetermined value or more, the determiner determines such that the setting content of the job and the content of the help screen coincide.

5. The information processing apparatus according to claim 3, wherein the provider provides the useful tag to a page of the help screen.

6. The information processing apparatus according to claim 3, wherein the determiner further executes a second determination to determine whether or not the operation display has received execution start of a job and thereafter further has received a stopping operation of the job in middle of execution or a deleting operation for deliverables of the job within a predetermined period after the job has been completed, and then, only in a case where a determination result of the first determination is “Yes” and a determination result of the second determination is “No”, the provider provides the useful tag to the help screen and makes the memory unit memorize this matter.

7. The information processing apparatus according to claim 3, wherein the determiner further executes a third determination to determine whether or not the help screen provided with the useful tag has been displayed again in response to an operation from a user within a predetermined period after the job has been completed, and then, in a case where the third determination is “Yes”, the provider cancels the useful tag provided to the help screen.

8. The information processing apparatus according to claim 3, wherein the useful tag includes correspondence information to the operation screen that has received an operation for displaying the help screen.

9. The information processing apparatus according to claim 8, comprising:
a screen creator that creates an operation screen in which a link or link button for shifting to the help screen on a basis of the correspondence information of the useful tag is arranged on the operation screen that has received an operation for displaying the help screen.

10. The information processing apparatus according to claim 3, wherein the determiner executes a second determination to determine whether or not the operation display has received execution start of a job and thereafter further has received a stopping operation of the job in middle of execution or a deleting operation for deliverables of the job within a predetermined period after the job has been completed; and then, in a case where a determination result of the first determination is “Yes” and a determination result of the second determination is “No”, the provider provides a first useful tag of a rank 1 with a high usefulness to the help screen; and in a case where both determination results of the first and second determinations are “Yes”, the provider provides a second useful tag of a rank 2 with a usefulness lower that the rank 1 to the help screen and makes the memory unit memorizes this matter.

11. The information processing apparatus according to claim 3, further comprising:
an authentication processor that authenticates a user,
wherein in a case where a result of the first determination has become “Yes” by an operation by an authenticated user, the provider associates the useful tag with information on the authenticated user and makes the memory unit memorizes this matter.

12. The information processing apparatus according to claim 5, further comprising:
a measurer that measures a display time of each of displayed pages of the help screen,
wherein the provider provides a useful tag for a page with a display time being longest among a plurality of pages of the help screen.

13. The information processing apparatus according to claim 3, further comprising:
a state detector that detects a preliminarily notifying operation with regard to execution start of a job by a user and detects a cancelling operation for the preliminarily notifying operation,
wherein in a case where, after having detected the preliminarily notifying operation, the state detector detects a cancelling operation for the preliminarily notifying operation in a state that the job has not been executed, the determiner determines that help screens displayed during a period from the detection of the preliminarily notifying operation to the detection of the cancelling operation are useless, and the provider provides a useless tag indicating as being useless guidance information to the help screens and makes the memory unit memorizes this matter.

14. The information processing apparatus according to claim 13, wherein the detection of each of the preliminarily notifying operation and the cancelling operation is at least any of (1) a coin throwing operation to a coin vendor for executing a job and a coin returning operation; (2) an operation for obtaining usage permission for the information processing apparatus by making an authentication processor authenticate a user so as to shift to an authenticated state and a cancelling operation for the authenticated state; (3) a loading operation for loading a document onto a document reader and a removing operation; and (4) a connecting operation for connecting an external portable memory to the information processing apparatus and a disconnecting operation.

15. The information processing apparatus according to claim 13, further comprising:
an output unit that extracts combination information of the help screen provided with the useless tag and the operation screen made to correspond to the help screen from the memory unit, wherein the useless tag includes correspondence information to the operation screen having received an operation for displaying the help screen, and that transmits the extracted combination information to an external server.

16. The information processing apparatus according to claim 13, further comprising:
an authentication processor that authenticates a user,
wherein, in the case where the useless tag has been provided by the determiner during an operation of an authenticated user, the provider associates the authenticated user information with the useless tag and makes the memory unit memorize this matter.

17. The information processing apparatus according to claim 1, wherein the information processing apparatus is an image processing apparatus that processes image data obtained by reading a document.

18. A non-transitory recording medium storing a computer-readable control program that is executed in an information processing apparatus including an operation display that displays an operation screen with regard to setting of a job and receives an operation by a user through the operation screen and a memory unit that memorizes the operation screen and a plurality of help screens to show guidance information with regard to an operation or setting on the operation screen and memorizes by associating the operation screen and at least one of the plurality of help screens, and is adapted to make a computer execute processing, the processing comprising:
executing, as determination of usefulness, a first determination that determines whether or not a setting content of a job and a content of a help screen coincide, in a case of having displayed the help screen on the operation display and thereafter having received execution start of the job corresponding to the operation screen associated with the help screen;
providing an identifier indicating as being useful guidance information to the help screen determined as being “Yes” in a determination result of the first determination; and
making the memory unit memorize this matter.

19. A control method that is executed in an information processing apparatus including an operation display that displays an operation screen with regard to setting of a job and receives an operation by a user through the operation screen and a memory unit that memorizes the operation screen and a plurality of help screens to show guidance information with regard to an operation or setting on the operation screen and memorizes by associating the operation screen and at least one of the plurality of help screens, the control method comprising:
executing, as determination of usefulness, a first determination that determines whether or not a setting content of a job and a content of a help screen coincide, in a case of having displayed the help screen on the operation display and thereafter having received execution start of the job corresponding to the operation screen associated with the help screen;
providing an identifier indicating as being useful guidance information to the help screen determined as being “Yes” in a determination result of the first determination; and
making the memory unit memorize this matter.
